(19) United States
(12) Patent Application Publication
(10) Pub. No.: US 2013/0198637 A1
(43) Pub. Date: Aug. 1, 2013

(54) CLOUD SERVICE DASHBOARD

(71) Applicant: SunGard Availability Services LP, Wayne, PA (US)

(72) Inventors: Jerry W. Childers, JR., Philadelphia, PA (US); Satish K. Hemachandran, Newnan, GA (US); Nischal Vohra, Pune (IN)

(73) Assignee: SunGard Availability Services LP, Wayne, PA (US)

(21) Appl. No.: 13/749,933

(22) Filed: Jan. 25, 2013

Related U.S. Application Data
(60) Provisional application No. 61/591,461, filed on Jan. 27, 2012.

(51) Int. Cl. H04L 12/24

(52) U.S. Cl. CPC H04L 41/08
USPC 715/735

(57) ABSTRACT

Techniques for displaying cloud services availability and configuration information which have particular applicability in an environment where a cloud service provider offers virtual data center services to numerous commercial customers.

### CROSS-REFERENCE TO RELATED APPLICATIONS

The present application claims the benefit of U.S. Provisional Patent Application Ser. No. 61/591,461, filed on Jan. 27, 2012 for a CLOUD SERVICE DASHBOARD and which is hereby incorporated by reference.

BACKGROUND

1. Field of the Invention

This patent application relates to implementation of data processing infrastructure elements as a cloud service, and in particular to techniques for coordinating and displaying cloud services availability, configuration and status information.

2. Background Information

The users of data processing equipment increasingly find the Virtual Data Center (VDC) to be a flexible, easy, and affordable way to access the services they need. By moving infrastructure and applications to cloud based servers accessible over the Internet, these customers are free to build out equipment that exactly fits their requirements at the outset, while having the option to adjust with changing future needs on a “pay as you go” basis. VDCs, like other cloud-based services, bring this promise of scalability to allow expanding servers and applications as business needs grow, without having to spend for unneeded hardware resources in advance. Additional benefits provided by professional level cloud service providers include access to equipment with superior performance, security, disaster recovery, and easy access to information technology consulting services.

Beyond simply moving hardware resources to a remote location accessible “in the cloud” via a network connection, virtualization is a further abstraction layer of VDCs that makes them attractive. Virtualization decouples physical hardware from the operating system and other information technology and resources. Virtualization allows multiple virtual machines with different operating systems and applications to run in isolation side by side on the same physical machine. A virtual machine is a software representation of a physical machine, specifying its own set of virtual hardware resources such as processors, memory, storage, network interfaces, and so forth upon which an operating system and applications are run.

### SUMMARY

Increasingly, cloud service providers are offering additional value-added services to Virtual Data Center (VDC) customers as a way of retaining existing customers and attracting new ones. Services being offered to customers include, for example, business continuity, load balancing, firewalls, and operating system management. These services are optional but subscribing to them may be beneficial to the use and operation of each individual VDC. For example, subscribing to a firewall service helps protects the virtual machines operating in the customer's VDC from outside attacks. As another example, subscribing to a load balancing service helps ensure workload is distributed evenly among the customer's virtual machines.

Because of these and other benefits it is not uncommon for one customer to subscribe to such services. However, there is no convenient way for a customer to see all services that the customer has subscribed to, which could be many. Of greater concern, the customer cannot see, at least not conveniently, important information related to a service, like how the service is configured or the heath and status of the service. For example, cloud service portals, such as those being offered by AMAZON and RACKSPACE only show information about the operational state of a customer's virtual machines to the customer.

These portal views do not, however, show information about services for those virtual machines or at a VDC level.

A customer's visibility into services is further limited by the lack of a convenient way to see additional services being offered for subscription by the cloud service provider.

What is needed is a cloud service dashboard, a single point for looking at services that a customer has subscribed to and, in particular, for looking at information together with about the configuration and health (or status) of subscribed to services. This information should be visible ideally at least on a per VDC basis. There is also a need for such a dashboard to show a customer which additional services are available for subscription.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a high level diagram of a cloud infrastructure service environment that includes a Virtual Data Center (VDC).

FIG. 2 is an example landing page of an user interface portal accessible by a customer (user) of the cloud service.

FIG. 3 is a VDC status screen.

FIG. 4 is a Virtual Machine (VM) performance screen.

FIG. 5 is a services tab view of the cloud service dashboard.

FIG. 6 is another view of the services tab of the dashboard.

FIG. 7 shows a load balancing service configuration screen of the dashboard.

FIG. 8 shows a firewall service configuration screen.

### DETAILED DESCRIPTION OF AN ILLUSTRATIVE EMBODIMENT

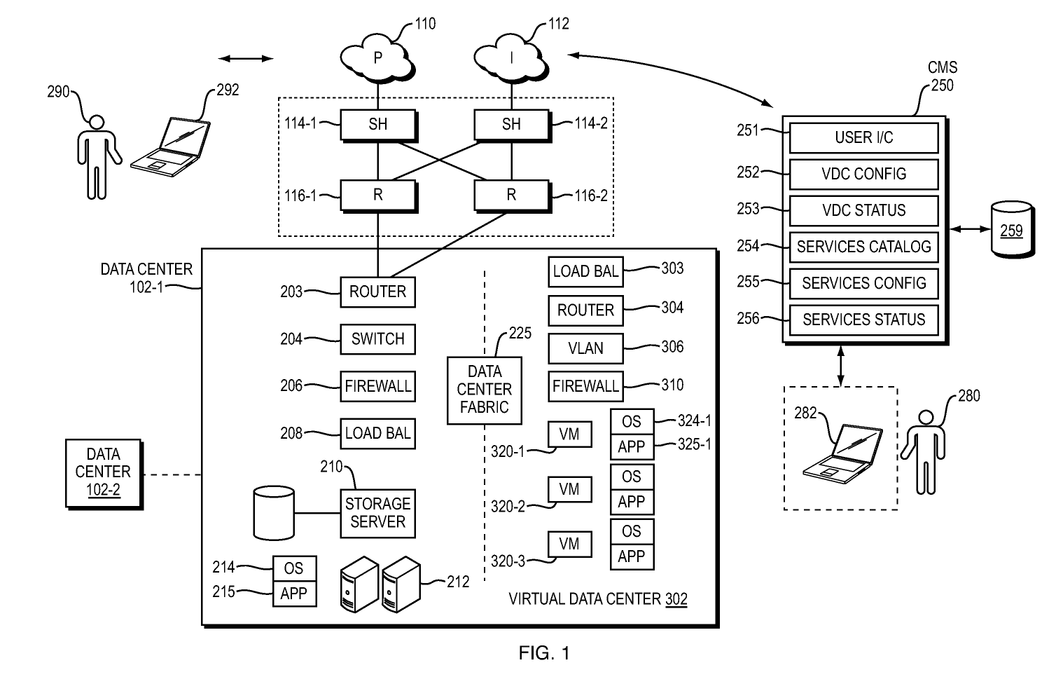

FIG. 1 is a high level diagram of a typical cloud based information technology (IT) environment in which improved cloud service dashboard procedures and apparatus described herein may be used. It should be understood that this is but one example IT environment and many others are possible.

The illustrated IT environment is implemented at a cloud service provider location 100 which makes available one or more data centers 102-1, 102-2 . . . to one or more cloud service customers (also called users). The service provider environment (the example used here is an Infrastructure as Service (IaaS) provider) includes physical connections to various networks such as a private network 110 and the Internet 112 through various switches 114-1, 114-2 and or routers 116-1, 116-2. The data center level switches 114 and routers 116 provide ingress and egress to the several data centers 102-1, 102-2 that are hosted at the particular service provider location 100.

In some implementations, these data center level switches 114 and routers 116 are considered to be part of the service provider's infrastructure and thus are not considered to be part of the cloud infrastructure elements that are configurable by the customer directly or considered to be part of the data centers 102. It is possible, for example, that the details of the operation of the service provider level physical switches 114 and routers 116 are kept hidden from and are not of concern to the customer. However, in other instances the data center level switches and routers (or portions thereof) may very well be part of the service customer's infrastructure elements and therefore configurable by the customer.

An example data center 102 includes a number of physical and virtual infrastructure elements. These infrastructure elements may include, but are not limited to, physical networking equipment such as routers 203, switches 204, firewalls 206, and other equipment such as load balancers 208, storage subsystems 210, and physical servers 212. The servers 212 may include web servers, database servers, application servers, storage servers, security appliances or other type of machines. Each server 212 typically includes an operating system 214, application software 215 and other data processing services, features, functions, software, and other aspects. A data center fabric 225 interconnects the various infrastructure elements in the data center 102 and is not shown in detail for the sake of clarity.

It should also be understood that while only a single type of each infrastructure element is shown, a given Virtual Data Center 302 may have multiple routers 304, firewalls 310, VLANs 306 and even other virtual machines such as load balancers, storage servers, application servers and the like that are not shown in detail herein.

Most IaaS service providers also support infrastructure elements arranged in virtual machine clusters or so-called Virtual Data Centers 302 (VDCs). VDCs are defined as a set of virtual machines, virtual networks, and other associated Infrastructure as a Service (IaaS) components. The elements of a VDC may be implemented on one or more physical machines, network devices, computing resources, or other data processing components. It is typical that multiple virtual machines 320-1, 320-2, 320-3 are considered to be part of a VDC 302. Each of the VM's 320 typically includes an operating system 324 and applications 325 and has access to various resources such as virtual memory, disk storage, and other resources. Included in a VDC 302 may be such other virtual resources as load balancers 303, virtual routers 304, virtual local area networks (VLANs) 306, virtual firewalls 310, and so forth.

The VDC 302 typically also includes other services that can be configured by the service customer in various ways. Examples of these services may include backup protection, secondary site failover, operating system patch management, and so forth. Depending on the type of services included, the VDC 302 will include custom policy definitions associated with each service on a per customer, per VDC, or per VM basis. An example of a service policy for a backup service is to specify a backup schedule that starts at Midnight Pacific Standard Time every 24 hours.

The cloud service provider/operator of the data centers 102-1, 102-2 typically supports many different end customers and therefore many different VDCs 302 are typically provisioned and active at any given time. These many different VDCs 302 are under control of a corresponding number of different administrative users associated with the customers who each expect to be able to configure their cloud infrastructure and services that the service provider has offered. An administrative user 290 associated with each such service customer therefore has access to a Configuration Management System (CMS) 250. The CMS 250 allows the administrator user(s) 290 of each customer to interact with and configure his virtual data centers 302 using a data processor 292 such as a personal computer.

In addition, there might also be other users 280 who need full or partial access to the same data represented in the CMS 250 via a separate interface and data processor 282. Specifically, these other users could be administrative staff within the service provider who need to review the each customers configuration, usage, modification, etc. for any business or technical reasons to ensure reliable operation of the IT environment for all customers.

The CMS 250 may be located in the same physical location as the data center 102, elsewhere the premises of the service provider 100, at the customer premises, or remotely located and securely accessing the data center through either the private network 110 or the Internet 112.

The CMS 250 includes one or more data processor components that provide various functions and store various information. These data processor components may include computer programs and/or logic to provide functions including a user interface 251, a VDC configurator 252, VDC status 253, services catalog 254, services configurator 255 and services status 256. The CMS 250 may typically also make use of an information store 259 such as a database, memory or other suitable device for storing information that can be accessed by these functions.

The user interface component 251 provides the various input/output screens to users 280 and/or 290 by communication with their associated data processing devices 282, 292. Example user interface screens implemented as a web portal will be described in more detail below.

The VDC configurator 252 component contains logic to permit the users 280, 292 to specify and configure infrastructure elements of the VDC's 302. The VDC configurator may also store information needed in the information store 259 concerning the configuration of the various VDC's 302.

The VDC status 253 component maintains current status information for the various infrastructure elements of the VDC's 302.

The services catalog 254 component maintains information concerning the various available services that users 280, 290 may apply to one or more infrastructure elements of their VDC's 302.

The services configuration component 255 maintains information concerning the configuration of the various services that the users have selected and applied to the various VDC elements.

The services status component 256 maintains current status information concerning the various services.

Examples of the types of cloud services can be made available, their configuration and status information will be described in greater detail below.

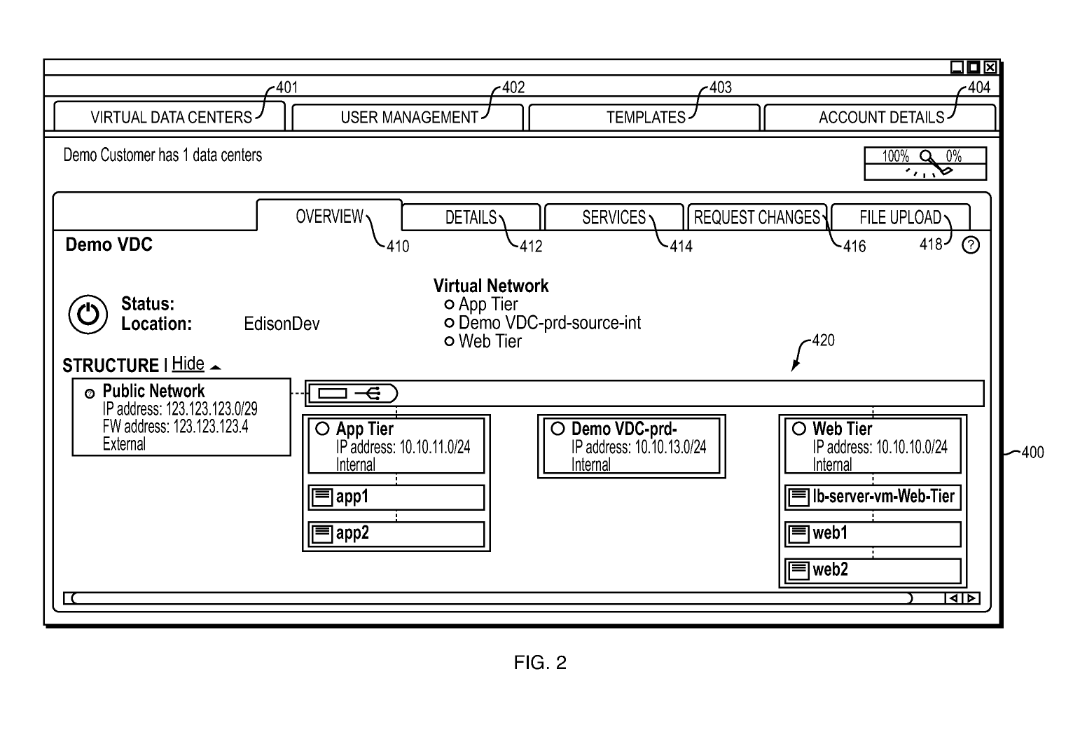

FIGS. 2-8 illustrate example user interface screens that the users 280 and/or 290 using CMS 250 may utilize to specify configurations and services and view the status of the same.

FIG. 2 is an example landing page or initial screen that a user 280 and/or 290 may see upon first interaction with the interface component 251. This customer landing page screen may have a number of high-level tabs including virtual data centers 401, user management 402, templates 403 and account details 404 tabs.

In this example under the active virtual data centers tab 401 there are seen further tabs available for overview 410, details 412, services 414, request changes 416 and file upload 418.

In this example the customer 280 has configured a single VDC 302 named “Demo VDC.” The Demo VDC includes three virtual networks named “App tier”, “Demo VDC-prd-source-int”, and “web tier”. These three networks, as shown in the pictorial representation, included five virtual machines (VMs) that have been configured including app1, app2, 1b-server-vm-web-tier, web1 and web2.

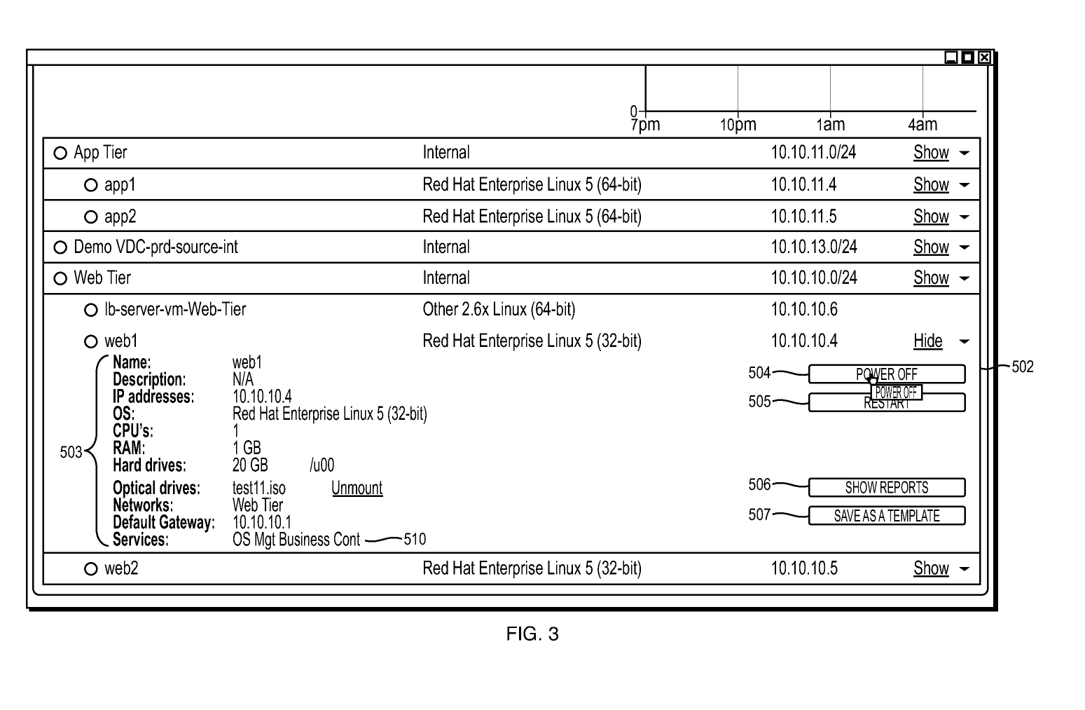

From such a landing page the user may select the details tab 412 and be shown a view such as that of FIG. 3. Here, more details of the VDC configuration can be accessed. For example it can now be seen that various operating systems installed on the various virtual machines include Red Hat Enterprise Linux 5 (64 bit and 32 bit) and Other 2.6 Linux (64-bit), as well as the network addresses assigned to each VM.

A further portion of this screen includes a drop-down control 502 that may be activated to show or hide the details of each VM in the VDC. Here the user 280 has selected to show the detail for the web1 VM by activating control 502. This then shows various attributes of the configured web1 including its name, description, IP addresses, operating system, number of CPUs, available storage (RAM, hard drives, optical drives), connected networks and default gateway. A number of buttons may also be activated in this view to control the status of the web1 VM, including a power off 504, restart 505, five, show reports 506 and template 507 buttons.

Of more interest here is that detail screen 503 also includes a list of enabled services for the web1 VM. Here enabled services for this VM include operating system management and business continuity.

While what is shown in FIG. 3's is an example detail view for a single VDC and a single VM for that VDC it should be understood that similar views could be enabled by clicking on the show hide details button 502 for the other VM's.

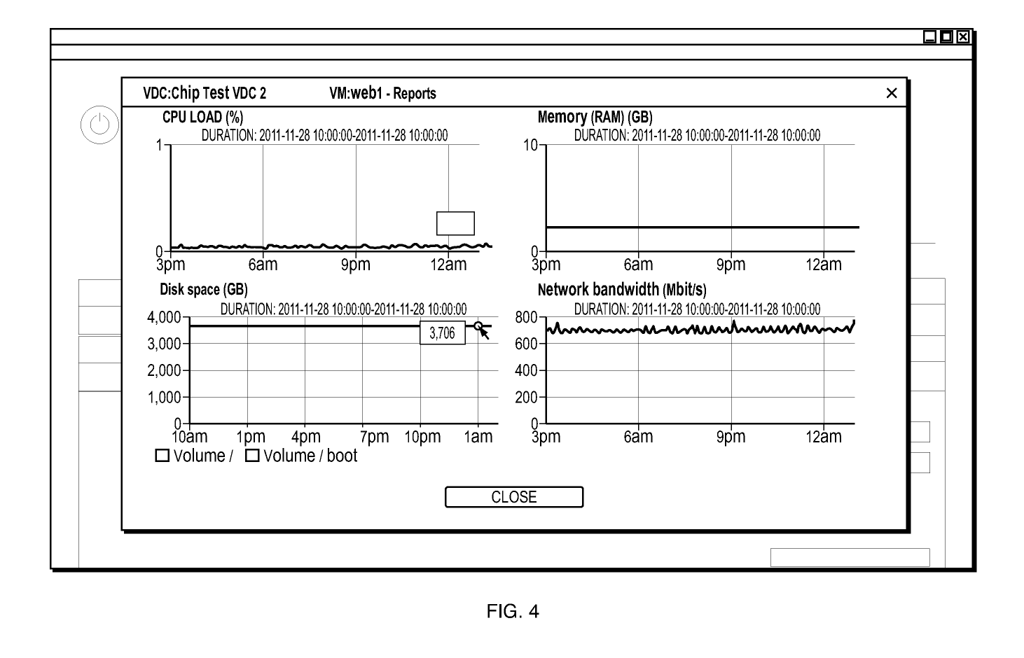

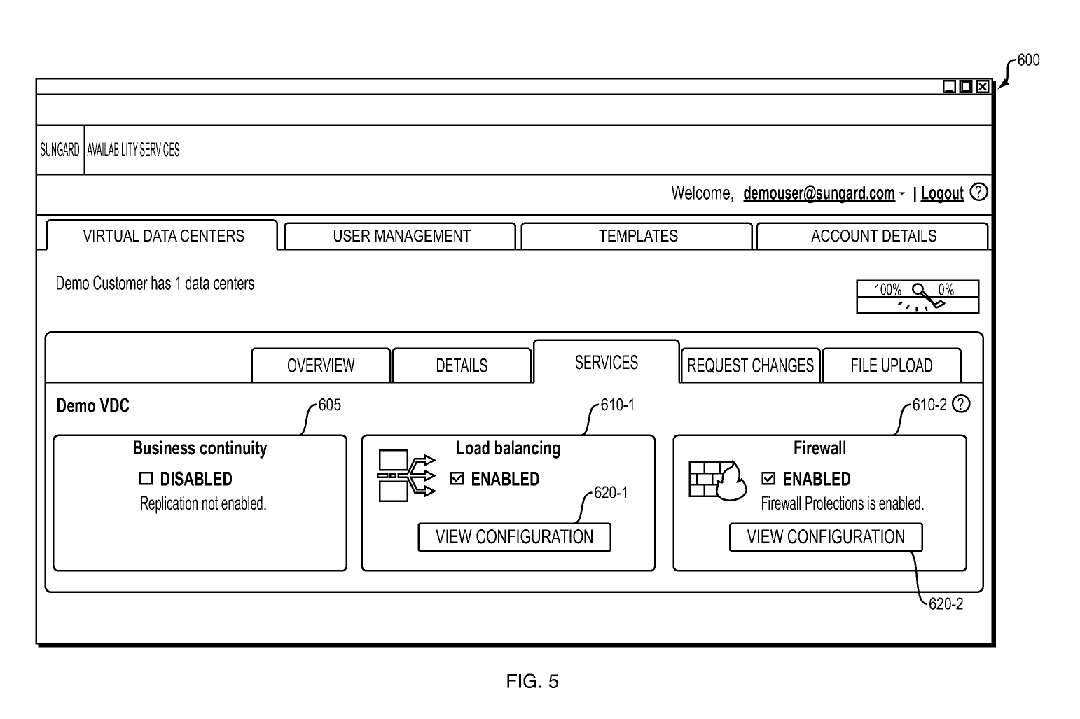

VM performance information can also be viewed by selecting an appropriate reports tab, with the resulting screen shown in FIG. 4. Here the web1 VM is selected to illustrate performance metrics such as CPU load, memory usage, disk space and network bandwidth. It can now be understood how this “performance” and “status” information in FIG. 4 is different from the configured services information described above for FIG. 3 and as will be shown in FIG. 5.

More specifically, FIG. 5 shows a screenshot of an example cloud service dashboard 600 that can be displayed by selecting the services 414 under the Virtual Data Centers 401 tab on the main landing page 400 of FIG. 2. The cloud service dashboard 600 shows the set of services that are available to the customer at a VDC level, and information related to these services. For ease of reference in describing example embodiments, a service being offered to a customer 280, but to which the customer 280 has not yet subscribed, is called an “offered service” and a service to which the customer has subscribed is called a “subscribed service.”

The cloud service dashboard 600 shows one such offered service 605, a so-called “business continuity” service. The offered service 605 is shown as graphical icon accompanied by an empty checkbox and the text “disabled.” Other representations of the offered service 605 are also possible. An “offered” service is identifiably by the CMS as a service which is listed as being available in the services catalog 254 but not yet indicated as active in the services configuration 255.

The cloud service dashboard 600 also shows subscribed services 610-1 and 610-2 called “load balancing” and “firewall,” respectively, for the selected Demo VDC. Each of subscribed services, 610-1, 610-2, is shown as a graphical icon accompanied by a filled-in checkbox accompanied by the text “enabled.” Other representations of the subscribed services, 610, are also possible. It should also be understood that other cloud services not shown in FIG. 5 might be available such as OS patch management, etc.

For each of the subscribed services 610-1, 610-2, the cloud service dashboard 600 provides, under a service heading, a corresponding customer-selectable element labeled “view configuration” 612-1, 612-2. In response to the customer selecting a “view configuration” option under a given service heading, the cloud service dashboard 600 then shows further information about that selected service to the user 280.

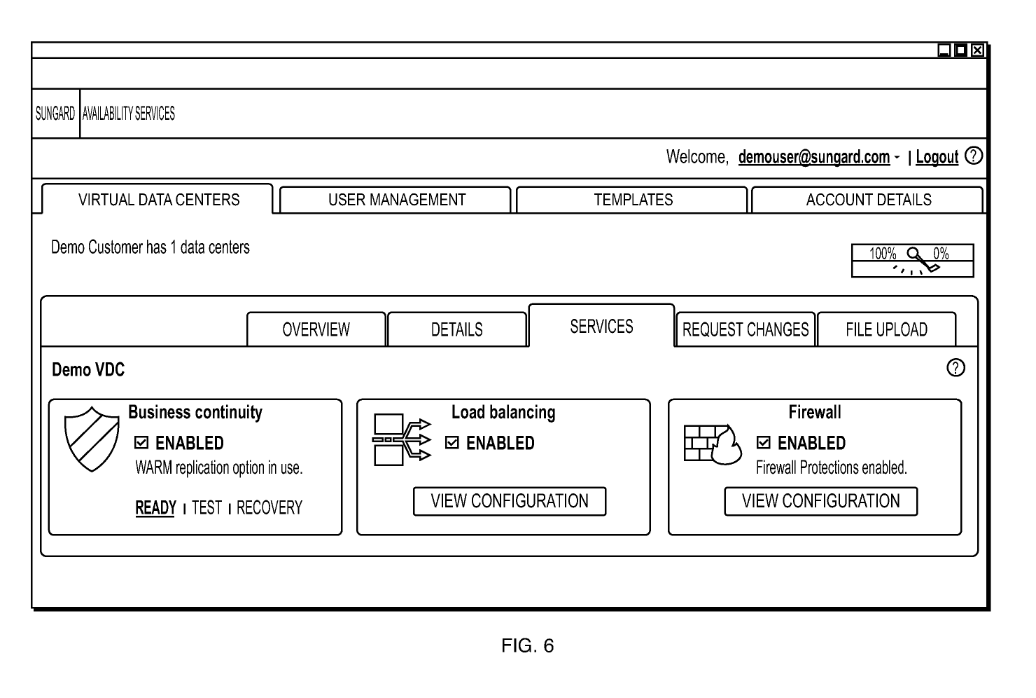

FIG. 6 illustrates the same dashboard after the user has enabled the business continuity service. Here the customer/user 280 can confirm a mode of deployment for this service (“warm replication option”) and its status (“Ready”). The user may optionally interact with the service by executing a Test or Recovery function provided by the business continuity service.

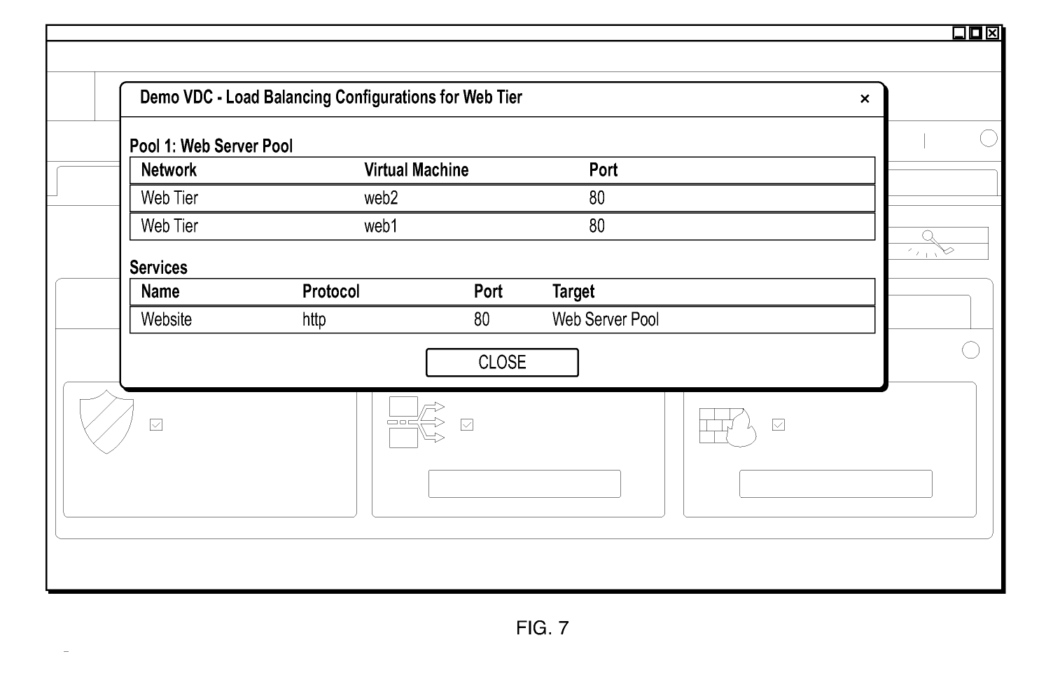

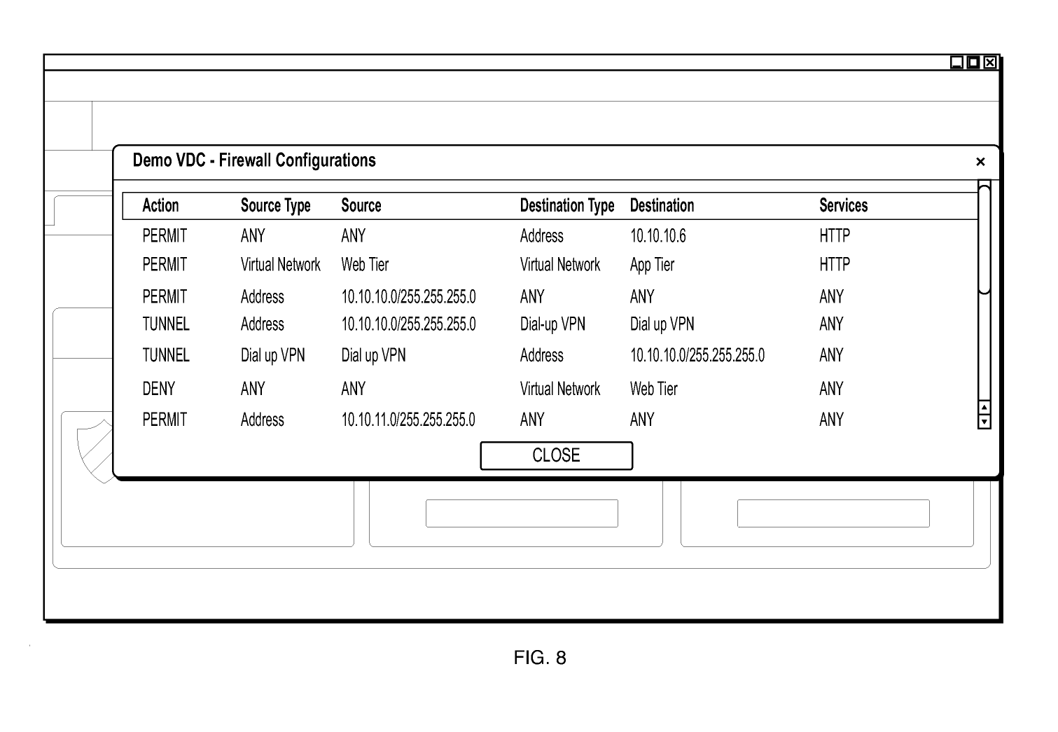

FIGS. 7 and 8 show screenshots of information related to the configuration of load balancing 610-1 and firewall 610-1 services. The cloud service dashboard 600 thus also provides a customer 280 with a detailed view of the configuration of the selected load balancing service, in response to an input by the customer (e.g., by selecting the “view configuration” 620-1 button as described above in connection with FIG. 5). According to an example embodiment, the customer can then use the provided configuration view of FIG. 7 to edit attributes or parameters of the load balancing service at the VDC level.

FIG. 8 is a similar configuration view presented for the firewall service 610-2.

In a convenient embodiment, the cloud service dashboard thus shows a description of each service being offered by the cloud service provider and/or subscribed to by the customer.

In another convenient embodiment, for each service shown by the cloud service dashboard, the cloud service dashboard also shows a customer the terms and conditions of an associated service level agreement. Alternatively, the cloud service dashboard may send copies of the service level agreements to the customer so that the customer can view them later in time.

In yet another convenient embodiment, the cloud service dashboard is provided to the customer as a webpage. The webpage may be transmitted to the customer from a server residing in a management network operated by the cloud service provider.

Having described example embodiments of the cloud service dashboard, use of the cloud service dashboard will now be described in more detail in reference to FIGS. 5 and 6.

In use, an IaaS customer users 280 and/or administrative user 290 logs into the Configuration Manager System (CMS) 250 (e.g., by entering a username and password) that provides access via user interface 251 to the cloud service dashboard 600.

The cloud service dashboard 600 then shows services that the customer has subscribed to (subscribed services) for a specific VDC 302 (as indicated by services configurator 255), services that are being offered for subscription by the cloud service provider (offered services) (such as by comparing services configurator 255 data for the specific VDC with data from the offered services catalog 254), and status information related to these services (as provided by services status 256).

Referring again to FIG. 5, the customer sees that a business continuity service is being offered for subscription. The customer wants to subscribe to the service. The customer selects the graphical icon representing the business continuity service 605. In response to the customer's selection, the cloud service dashboard 600 asks the customer to configure the business continuity service. Alternatively, in another embodiment, the cloud service dashboard 600 provides a default or sample configuration, which can be customized or modified according to the customer's needs, for example.

Referring again to FIG. 6, once the business continuity service is configured, the cloud service dashboard 600 now shows that the customer and/or user has successfully subscribed to the business continuity service 620 by way of a filled-in checkbox and accompanying text “enabled”.

Referring to both FIGS. 5 and 6, the customer 280 can not only see that he has subscribed to the load balancing service, but can also request more information about the service from the same dashboard view. Under the load balancing service heading, the customer can select the “view configuration” tab that is provided by the cloud service dashboard 600. In response to the customer's selection, the cloud service dashboard 600 then shows the customer information related to the load balancing service (e.g., the load-balancing configuration of FIG. 7).

In another scenario, the customer can see that he has subscribed to the firewall service for the VDC, but now wants to stop subscribing to that service. Under the firewall service heading, the customer can merely uncheck the associated checkbox. In response to the customer's action, the cloud service dashboard 600 can show that the firewall service is disabled and that the specific VDC is no longer subscribed to the service.

In another embodiment, in response to the customer unchecking the checkbox to disable the service, the cloud service dashboard 600 asks the customer to confirm the action and/or the customer's intent. Once the service is disabled, the cloud service dashboard 600 may send a confirmation to the customer notifying that the customer has successfully unsubscribed from a service.

In the foregoing example embodiments described in reference to FIGS. 5 through 8, the cloud service dashboard shows services that are subscribed to and applied at the level of a customer's VDC. However, in another embodiment, one of finer granularity with respect to visualization of configured services, the cloud service provider can show services that are applied at the level of each virtual machine (VM) operating within a VDC. The cloud service dashboard can thus show service information on a per virtual machine basis, such as was discussed and shown in connection with FIG. 3.

In another embodiment, in the process of showing subscribed services and offered services, as well as showing information related to these services to a customer, the cloud service dashboard 600 may read metadata called a “cloud service profile” that is part of Services Configuration 255. The cloud service profile may be encoded as an Extensible Markup Language (XML) document according to one example embodiment.

According to another example embodiment, the cloud service profile is a structured data entity written in Structured Query Language (SQL) and stored in a relational database 259. Examples of such cloud services profiles are further provided in our co-pending U.S. Patent Application entitled “CLOUD CONFIGURATION—CREATING, TRACKING, AND REVIEWING CHANGES USING A COMMON DATA MODEL” Ser. No. 13/599,288 filed Aug. 30, 2012, which is hereby incorporated by reference.

### Implementation Options

It should be understood that the example embodiments described above may be implemented in many different ways. In some instances, the various “data processors” described herein may each be implemented by a physical or virtual general purpose computer having a central processor, memory, disk or other mass storage, communication interface(s), input/output (I/O) device(s), and other peripherals. The general purpose computer is transformed into the processors and executes the processes described above, for example, by loading software instructions into the processor, and then causing execution of the instructions to carry out the functions described.

As is known in the art, such a computer may contain a system bus, where a bus is a set of hardware lines used for data transfer among the components of a computer or processing system. The bus or busses are essentially shared conduit(s) that connect different elements of the computer system (e.g., processor, disk storage, memory, input/output ports, network ports, etc.) that enables the transfer of information between the elements. One or more central processor units are attached to the system bus and provide for the execution of computer instructions. Also attached to system bus are typically I/O device interfaces for connecting various input and output devices (e.g., keyboard, mouse, displays, printers, speakers, etc.) to the computer. Network interface(s) allow the computer to connect to various other devices attached to a network. Memory provides volatile storage for computer software instructions and data used to implement an embodiment. Disk or other mass storage provides non-volatile storage for computer software instructions and data used to implement, for example, the various procedures described herein.

Embodiments may therefore typically be implemented in hardware, firmware, software, or any combination thereof.

The computers that execute the processes described above may be deployed in a cloud computing arrangement that makes available one or more physical and/or virtual data processing machines via a convenient, on-demand network access model to a shared pool of configurable computing resources (e.g., networks, servers, storage, applications, and services) that can be rapidly provisioned and released with minimal management effort or service provider interaction. Such cloud computing deployments are relevant and typically preferred as they allow multiple users to access computing resources as part of a shared marketplace. By aggregating demand from multiple users in central locations, cloud computing environments can be built in data centers that use the best and newest technology, located in the sustainable and/or centralized locations and designed to achieve the greatest per-unit efficiency possible.

In certain embodiments, the procedures, devices, and processes described herein are a computer program product, including a computer readable medium (e.g., a removable storage medium such as one or more DVD-ROM's, CD-ROM's, diskettes, tapes, etc.) that provides at least a portion of the software instructions for the system. Such a computer program product can be installed by any suitable software installation procedure, as is well known in the art. In another embodiment, at least a portion of the software instructions may also be downloaded over a cable, communication and/or wireless connection.

Embodiments may also be implemented as instructions stored on a non-transient machine-readable medium, which may be read and executed by one or more procedures. A non-transient machine-readable medium may include any mechanism for storing or transmitting information in a form readable by a machine (e.g., a computing device). For example, a non-transient machine-readable medium may include read only memory (ROM); random access memory (RAM); magnetic disk storage media; optical storage media; flash memory devices; and others.

Furthermore, firmware, software, routines, or instructions may be described herein as performing certain actions and/or functions. However, it should be appreciated that such descriptions contained herein are merely for convenience and that such actions in fact result from computing devices, processors, controllers, or other devices executing the firmware, software, routines, instructions, etc.

It also should be understood that the block and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and thus the computer systems described herein are intended for purposes of illustration only and not as a limitation of the embodiments.

While this invention has been particularly shown and described with references to example embodiments thereof, it will be understood by those skilled in the art that various changes in form and details may be made therein without departing from the scope of the invention encompassed by the appended claims.

What is claimed is:

1. A method for managing a configuration of elements of an infrastructure as a service (IaaS) environment operated by a cloud provider, where the environment includes two or more infrastructure elements that are configurable into one or more cloud computing environments by a user, the method comprising:
collecting operational status information for one or more of the infrastructure elements;
collecting cloud service availability information for one or more cloud services that can be implemented for one or more of the infrastructure elements;
collecting cloud service configuration information via input from the user;
storing the status information, the cloud service availability information, and the cloud service configuration information;
selecting portions of the infrastructure status information, the cloud service availability information, and the cloud service configuration information for presentation to the user, including a further step of comparing the infrastructure status information, the cloud service availability information and the cloud service configuration information to determine cloud services that are enabled for a specific infrastructure element and cloud services that are available, but not enabled, for a specific infrastructure elements; and
presenting the selected portions of the information, including presenting information representative of which cloud services are enabled and which cloud services are available, but disabled, to the user.

2. The method of claim 1 further comprising:
displaying configuration information for at least one of the enabled services.

3. The method of claim 1 further comprising:
accepting input information from the user indicative of a change to be made to a cloud service to be applied to one or more of the infrastructure elements.

4. The method of claim 1 wherein the cloud service configuration information is stored as an XML or SQL format data file.

5. The method of claim 1 further comprising:
accepting input information from the user indicative of a change to be made to a configuration of one or more of the infrastructure elements.

6. The method of claim 1 wherein the cloud service availability information and the cloud service configuration information are maintained for a Virtual Data Center (VDC) as a collection of two or more infrastructure elements, such that a given cloud service, when enabled, is enabled for all infrastructure elements of the VDC.

7. The method of claim 1 wherein the cloud service availability information and the cloud service configuration information are maintained for each Virtual Machine (VM) in a Virtual Data Center (VDC), the VDC configured as two or more infrastructure elements, such that a given cloud service, when enabled, is applied to each VM independent of application of services to other VMs in the VDC.

8. The method of claim 7 wherein the cloud services comprise one or more of business continuity, load balancing, and firewall services.
